(19) United States
(12) Patent Application Publication
(10) Pub. No.: US 2009/0043869 A1
(43) Pub. Date: Feb. 12, 2009

(54) SYSTEM AND METHOD FOR DISTRIBUTING TIME-BASED MEDIA CONTENT

(75) Inventors: Mark A. Hansen, Denver, CO (US); Kevin D. Schaff, Littleton, CO (US); Mark W. Lemmons, Arvada, CO (US); Cameron A. Pope, Denver, CO (US); Kevin D. Murray, Brighton, CO (US)

Correspondence Address: BAKER BOTTS L.L.P., 2001 ROSS AVENUE, SUITE 600, DALLAS, TX, 75201-2980, US

(73) Assignee: Thought Equity Management, Inc., Denver, CO (US)

(21) Appl. No.: 11/834,809

(22) Filed: Aug. 7, 2007

(51) Int. Cl. G06Q 10/00; G06F 15/16; H04N 7/173

(52) U.S. Cl. 709/219; 705/1; 725/86

(57) ABSTRACT

A method for distributing time-based media files includes executing an agreement with a subscriber that relates to a plurality of time-based media files. The method also includes communicating to the subscriber an identifier for transmission to a plurality of display devices. The identifier identifies a location of at least a portion of the time-based media files associated with the agreement. The method also includes receiving a media request from one of a plurality of display devices that receive the identifier from the subscriber. The media request includes the bin identifier. The method also includes, in response to receiving the media request, transmitting a plurality of media files associated with the agreement to the display device that transmitted the media request.

### TECHNICAL FIELD OF THE INVENTION

This invention relates in general to information systems, and more particularly, to a method and system for distributing time-based media content to users.

### BACKGROUND OF THE INVENTION

The rapid expansion of the Internet and the growing number of content providers have made the Internet and other large-scale computer networks a critical part of modem distribution channels for media content. These distribution channels, however, create significant technological hurdles that many content providers, such as amateur artists and independent journalists, do not have the resources or expertise to overcome. Additionally, as more and more content providers transition to these types of distribution channels, downstream providers must develop robust, adaptable techniques for receiving and utilizing media content that is delivered over these channels.

### SUMMARY OF THE INVENTION

In accordance with the present invention, the disadvantages and problems associated with distributing time-based media content have been substantially reduced or eliminated. In particular, methods and systems are disclosed that provide flexible techniques for distributing and utilizing media content.

In accordance with one embodiment of the present invention, a method for distributing time-based media files includes executing an agreement with a subscriber that relates to a plurality of time-based media files. The method also includes communicating to the subscriber an identifier for transmission to a plurality of display devices. The identifier identifies a location of at least a portion of the time-based media files associated with the agreement. The method also includes receiving a media request from one of a plurality of display devices that receive the identifier from the subscriber. The media request includes the bin identifier. The method also includes, in response to receiving the media request, transmitting a plurality of media files associated with the agreement to the display device that transmitted the media request.

In accordance with another embodiment of the present invention, a system for distributing time-based media files comprises a display device, a web server, and a content server. The display device plays media files. The web server stores a webpage. The webpage comprises a bin identifier identifying a bin storing a plurality of time-based media files. The web server also receives a request for the webpage from the display device and transmits the webpage to the display device.

Furthermore, in this embodiment, the content server stores media files in each of a plurality of bins. The content server receives a request for media files that identifies one of the plurality of bins. In response to the request for media files, the content server transmits a plurality of the media files stored in the identified bin to the display device.

Technical advantages of certain embodiments of the present invention include flexibility and ease of implementation. Additionally, particular embodiments of the present invention may provide simplified techniques for syndicating and selling network-delivered media content. Other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 illustrates a particular embodiment of a system for distributing time-based media content from a content server to multiple display devices;

FIG. 2 is a block diagram illustrating in greater detail the contents of a particular embodiment of the content server utilized in the system illustrated in FIG. 1;

FIG. 3 XXX; and

FIG. 4 is a flowchart describing example operation of a particular embodiment of the system shown in FIG. 1. “capture as is” per instructions from

### DETAILED DESCRIPTION OF THE INVENTION

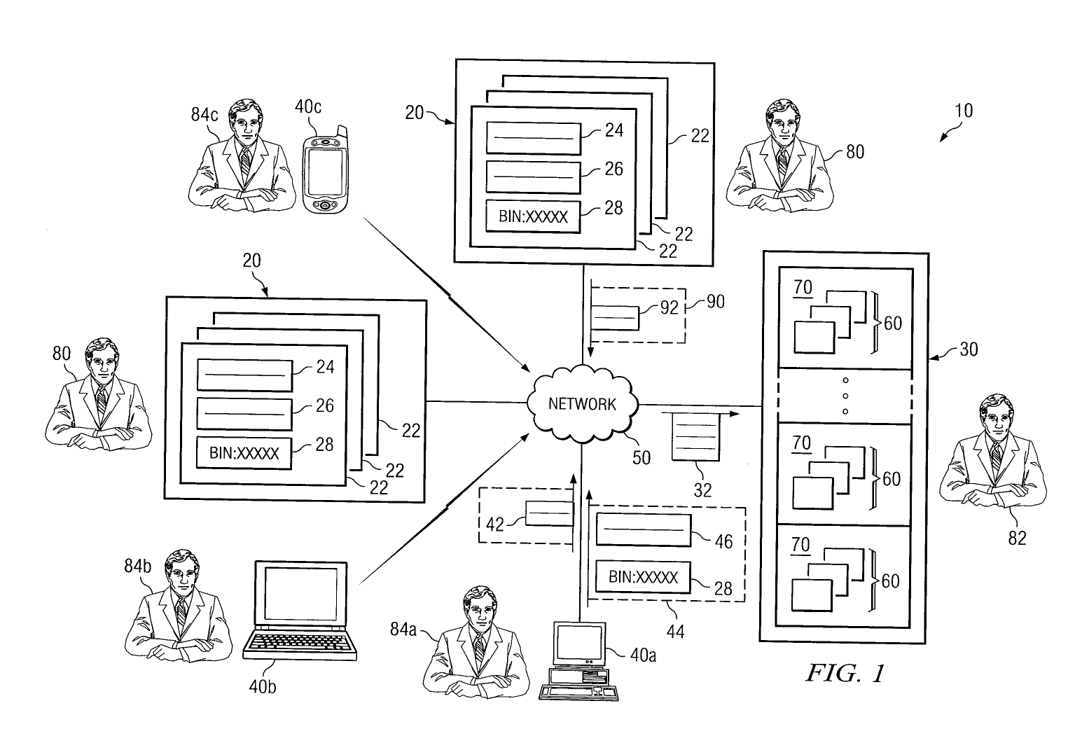

FIG. 1 illustrates a particular embodiment of a system 10 for delivering time-based media content to one or more display devices 40. As shown in FIG. 1, system 10 includes a web server 20, a content server 30, and multiple display devices 40 connected by a network 50. Collections of time-based media files 60 are stored on content server 30 in bins 70. As described in greater detail below, display devices 40 receive webpages 22 from web server 20 that identify bins 70 from which display devices 40 retrieve media files 60 for playback to users 84. Because webpages 22 can be easily adapted to identify different bins 70 and media files 60 can be dynamically associated with bins 70, system 10 may provide a flexible and effective solution for the distribution and management of time-based media. Additionally, in particular embodiments, content server 30 may deliver media files 60 directly to display devices 40 over network 50. As a result, in such embodiments, media files 60 may be delivered to display devices 40 without ever being stored on web servers 20 and without ever being in the possession or control of subscribers 80 that operate web servers 20.

Within system 10, web servers 20 store webpages 22 and deliver webpages 22 to display devices 40 in response to requests received from display devices 40. As discussed further below, certain web pages 22 delivered by web server 20 identify a bin 70 associated with that web page 22 from which display devices 40 can retrieve content. Web servers 20 may each represent any appropriate collection of hardware and/or software capable of serving information to other components over network 50. In particular embodiments, each web server 20 represents a Hypertext Transport Protocol (HTTP) server program (such as an Apache server program) and the computer that executes the program. Although FIG. 1 illustrates a particular embodiment of system 10 in which a particular number of web servers 20 operate in conjunction with content server 30, system 10 may, in general, include any number of web servers 20 utilizing the content of each content server 30.

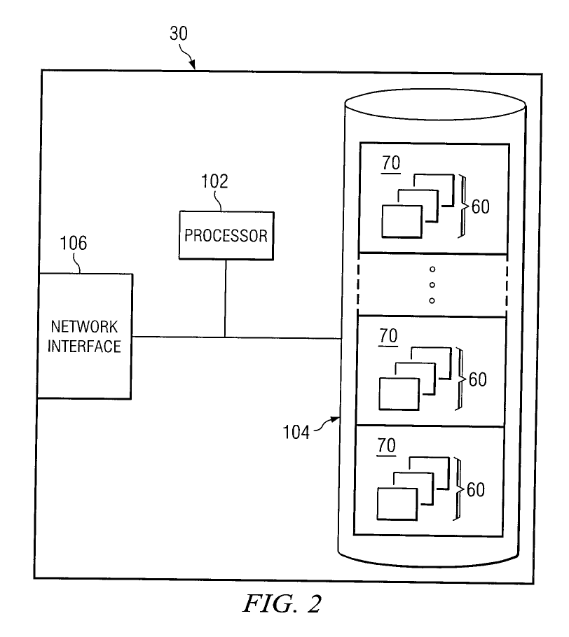

Content server 30 receives requests for media files 60 from display devices 40 and facilitates the transmission of media files 60 from an appropriate bin 70 to the requesting display devices 40. Although FIG. 1 illustrates, for the purpose of simplicity, an embodiment of system 10 in which content server 30 stores media files 60 locally, other devices within system 10 may, in alternative embodiments, store media files 60 and content server 30 may retrieve content from those devices as appropriate in responding to requests from display devices 40. In general, content server 30 may represent any appropriate collection of hardware and/or software suitable to provide the described functionality. The contents of a particular embodiment of content server 30 are described in greater detail below with respect to FIG. 2.

Media files 60 represent time-based media content that may be displayed, played, or otherwise presented by display devices 40. As used in this description and the claims that follow, “time-based media” refers to any form of content, data, and/or information that provides a time-varying visual, aural, and/or sensory experience when read, played, and/or displayed by an appropriate media player. Examples of time-based media include, but are not limited to, video, film, stop-motion imagery, animation, and other types of motion imagery; speech, music, sounds, and other forms of audio information and any combinations thereof. In particular embodiments, media files 60 represent Flash video (.flv) files. Although the description below and the claims that follow describe media files 60 as “files,” media files 60 may represent media content structured or transmitted in any appropriate manner. For example, media files 60 may each represent content streamed to a client, content transmitted to client as a series of packets or frames, and/or content structured and transmitted in any appropriate manner.

Bins 70 represent holders for media files 60. Bins 70 may represent file system folders, directories, or any other form of logical or physical partitions of memory in which a group media files 60 may be stored. In particular embodiments, each bin 70 holds a collection of associated media files 60. As one example, each bin 70 may hold a collection of media files 60 associated with a particular subscriber 80. As another example, each bin 70 may hold a collection of media files 60 that are all related to a particular subject or subjects. In general, however, bins 70 may hold media files 60 grouped in any suitable manner.

Agreement 32 may represent any appropriate form of agreement, contract, or understanding between one or more subscribers 80 and content provider 82 for content provision services relating to media files 60. Agreement 32 may identify media files 60 or types of media files 60 covered by agreement 32 and may include or define provisions such as licensing fees or other payments, restrictions associated with covered media files 60, and/or any other appropriate terms associated with the content services to be provided by content provider 82. In particular embodiments, agreement 32 may represent a standardized, click-through license accepted by all subscribers 80 utilizing content server 32 and/or services offered by content provider 82. In alternative embodiments, agreement 32 may represent a custom agreement the terms of which are negotiated by content provider 82 and a particular subscriber 80.

Although shown in FIG. 1 as a document, agreement 32 may, in particular embodiments, represent the terms of a verbal agreement and/or the rights and obligations of the relevant parties arising from such an agreement. Furthermore, in particular embodiments, agreement 32 may represent an implicit agreement arising between content provider 82 and one or more subscribers 80. For example, in particular embodiments, agreement 32 may represent terms that a subscriber 80 implicitly agrees to in using content services provided by content provider 82, such as terms of use, user agreements, or other rules governing use of services, content, and/or equipment (such as content server 30) offered by content provider 82.

Display devices 40 display content retrieved from content server 30 to users 84. Display devices 40 may each represent any device appropriate to receive input from a user 84 and to display media content to users 84 based on the received input. Examples of display devices 40 may include, but are not limited to, computers, interactive televisions, media-capable telephones, and portable communication devices. More generally, however, display devices 40 may include any appropriate combination of hardware and/or software suitable to provide the described functionality. Although FIG. 1 illustrates a particular number and type of display devices 40, alternative embodiments of system 10 may include any appropriate number and types of display devices 40.

Network 50 represents any form of communication network supporting circuit-switched, packet-based, and/or any other suitable type of communication. Although shown in FIG. 1 as a single element, network 50 may represent one or more separate networks, including all or parts of various different networks that are separated and serve different groups of display devices 40. Network 50 may include routers, hubs, switches, gateways, bridges, and/or any other suitable components in any suitable form or arrangement. In general, network 50 may comprise any combination of public or private communication equipment such as elements of the public-switched telephone network (PSTN), a global computer network such as the Internet, a local area network (LAN), a wide-area network (WAN), or other appropriate communication equipment.

Any appropriate number of entities may control or operate the elements of system 10, and the control and/or operation of the various elements may be divided among such entities in any appropriate manner. For example, in the illustrated embodiment, a content provider 82 and a subscriber 80 operate content server 30 and web server 20, respectively. Additionally, a plurality of users 84 operate the various display devices 40. In alternative embodiments, however, both content server 30 and web server 20 may be operated by a single entity. Moreover, each of subscribers 80, content provider 82, and users 84 may represent any combination of individuals and/or entities.

Content provider 82, in the illustrated embodiment, provides content services relating to time-based media files 60, such as content syndication, hosting, or management, and subscriber 80 subscribes to such content services. As one example, content provider 82 may represent a provider of syndicated content. Thus, in particular embodiments, content provider 82 may make syndicated content available for use by subscribers 80 such as news organizations. As described further below, subscribers 80 may then be able to incorporate the syndicated content provided by content provider 82 into web-accessible articles created by the subscribers 80.

As another example, content provider 82 may represent a content hosting service that stores and/or manages content owned by subscribers 80. Thus, content provider 82 may represent a content management service that handles for particular subscribers 80 transactions involving content created or owned by those subscribers 80. As a result, content provider 82 may host media files 60 created by a subscriber 80, and the subscriber 80 may be able to direct users 84 interested in such content to content server 30, as described further below.

Users 84 represent end-users of content supplied by system 10. Users 84 operate display devices 40. Additionally, in particular embodiments, users 84 may initiate transactions involving the transfer of rights in time-based media files 60 using system 10. For example, in particular embodiments, before, during, or after viewing content hosted by content server 30, users 84 may be able to purchase a copy of the content, license the content for certain uses, or otherwise acquire rights to the relevant content using system 10.

Prior to or during operation of system 10, content provider 82 and one or more subscribers 80 execute an agreement 32 or agreements 32 relating to particular media files 60 to be distributed by content provider 82. In particular embodiments, the relevant media files 60 may be owned or controlled by content provider 82. In such embodiments, content provider 82 and subscribers 80 may enter into an agreement 32 under which content provider 82 agrees to distribute media files 60 to users 84 to be played in conjunction with content (such as webpages 22) provided by subscribers 80. As a result, subscribers 80 may direct users 84 to content server 30 to access the media files 60, as described further below. In such embodiments, a particular subscriber 80 may never come into possession of or directly handle the media files 60 content provider 82 provides to users 84 on behalf of that subscriber 80.

In alternative embodiments, the media files 60 covered by agreement 32 may be owned by subscribers 80. Subscribers 80 may transmit the media files 60 to content provider 82 and convey appropriate rights in these media files 60 to allow content provider 82 to distribute the media files 60 to users 84. In such embodiments, a subscriber 80 may then direct users 84 accessing content (such as webpages 22) from a web server 20 operated by that subscriber 80 to content server 30 to access related media files 60. In particular embodiments, this may allow subscribers 80 with minimal technical expertise to easily distribute media files 60 they own or control.

Additionally, as part of executing agreement 32 with a particular subscriber 84, content provider 82 may communicate to that subscriber 80 information to be used by that subscriber 80 and/or users 84 to allow users 84 to access media files 60 covered by agreement 32. In particular embodiments, this information may include a location where the covered media files 60 will be stored. For example, media files 60 covered by agreement 32 may be stored in a bin 70 on content server 30 and content provider 82 may communicate to subscribers 80 (electronically or otherwise) a bin identifier 28 identifying the relevant bin 70 or its location. Additionally, content provider 82 may transmit to subscribers 80 code to be used by users 84 in accessing the media files 60.

Once agreement 32 has been executed between content provider 82 and a particular subscriber 80, users 84 may utilize display devices 40 to access media files 60 covered by the agreement 32 in conjunction with other content provided by subscribers 80. For example, in the illustrated embodiment, each subscriber 80 operates a web server 20 that hosts webpages 22. Each webpage 22 specifies one or more bins 70 storing content on content server 30. As part of displaying webpages 22, display devices 40 access and display media files 60 stored in the identified bin 70 or bins 70. As a result, system 10 provides a flexible and streamlined process for a subscriber 80 to provide a particular user 84 a collection of media files 60 that are associated with a particular webpage 22 accessed by that user 84, that the subscriber 80 believes user 84 may be interested in purchasing, or that the subscriber 80 otherwise desires user 84 to view.

More specifically, during operation, a display device 40 (for purposes of this example, display device 40a) requests a webpage 22 from web server 20. Display device 40a may request a webpage 22 in any appropriate manner based on the configuration and capabilities of display device 40a and web server 20. In particular embodiments, display device 40a transmits a webpage request 42, such as a Hypertext Transport Protocol (HTTP) request, identifying the requested webpage 22 to web server 20. In response to receiving webpage request 42, web server 20 transmits a particular webpage 22 to display device 40. For example, in particular embodiments, webpage 22 communicates the relevant webpage 22 to display device 40a as part of an HTTP response.

Webpage 22 includes one or more bin identifiers 28. Each bin identifier 28 represents information that identifies a bin 70 associated with the transmitted webpage 22. Bin identifiers 28 may identify the relevant bin 70 in any appropriate manner based on the configuration of system 10. In particular embodiments, bin identifiers 28 identify the relevant bin by the location, such as a Uniform Resource Location (URL). In alternative embodiments, the subscriber 80 that operates the relevant web server 20 may maintain an account with content provider 82, and webpage 22 may identify the subscriber 80 and/or an account associated with that subscriber 80.

In particular embodiments, webpage 22 may also include a player 24 and file parameters 26. Player 24 comprises instructions capable, when executed, of playing video, audio, and/or multimedia files received from content server 30. In particular embodiments, player 24 comprises an object representing a Flash project. The object is capable of receiving Hypertext Markup Language (HTML) or other forms of markup as a specific input and playing, pausing, and/or restarting Flash Media file (.flv) or other forms of media files 60. In particular embodiments, this object or “holder file” may be dynamically associated with and capable of playing some or all media files 60 stored in a particular bin 70. As a result, display device 40 may only need one player 24 and may only need to load that player 24 once to play any or all of the media files 60 stored in a particular bin 70.

File parameters 26 specify characteristics of media files 60 stored in the bin 70 identified by bin identifier 28. As described further below, display device 40 may utilize file parameters 26 when displaying media files 60 received from the corresponding bin 70. In particular embodiments, webpage 22 may communicate a separate set of file parameters 26 for each bin identifier 28 included in webpage 22. File parameters 26 may include, but are not limited to, such characteristics as the resolution, frame size, and aspect ratio of each identified media file 60.

Upon receiving webpage 22, display device 40a may display information included in webpage 22 to a user operating display device 40a (shown in FIGURE As an example, webpage 22 may represent a news article and display device 40a may display text of the news article to user 84a. As another example, webpage 22 may represent an entry in a weblog (or “blog”), and display device 40a may display the text and/or graphics included in the blog entry. Additionally, as part of displaying this information, display device 40a may load player 24. As noted above, player 24 may represent Flash code capable of playing media files 60 received from content server 30. In particular embodiments, display device 40a loads player 24 by executing instructions associated with player 24 and/or transferring executable code associated with player 24 to a cache for subsequent execution or use by display device 40a. Moreover, in particular embodiments, display device 40a loads player 24 only once for all media files 60 received from a particular bin 70 of content server 30.

Before, while, or after displaying the information included in webpage 22, display device 40 retrieves media files 60 from the bin 70 identified by the bin identifier 28 included in webpage 22. To retrieve media files 60 from the appropriate bin 70, display device 40a may transmit a media request 44 to content server 30. Media request 44 may represent or include any command, request, or message appropriate to induce content server 30 to transmit media files 60 from a particular bin 70 to display device 40a. In particular embodiments, media request 44 represents an HTTP request identifying the relevant bin 70.

In response to receiving media request 44, content server 30 begins transmitting media files 60 from the bin 70 identified by media request 44 to display device 40a. Content server 30 may transmit media files 60 to display device 40a as a continuous stream, a series of separate packets, a progressive download, or a collection of information structured in any other appropriate manner. In particular embodiments, content server 30 transmits all media files 60 from the identified bin 70 to display device 40a. For example, in particular embodiments, the relevant bin 70 may contain multiple related media files 60, and content server 30 transmits all media files 60 in that bin 70 to display device 40a. Alternatively, in particular embodiments, content server 30 may transmit a particular subset of the files included in the relevant bin 70 to display device 40a.

As one example, in particular embodiments, a particular bin 70 may hold multiple copies of each of the media files 60 stored by that bin 70. Content server 30 may identify particular copies to be transmitted to display devices 40 that request media files 60 from that bin 70. For example, in particular embodiments, display device 40a may transmit one or more device parameters 46 to content server 30 as part of media request 44. Device parameters 46 may define characteristics, capabilities, or features of display device 40a such as the display size of display device 40a, codecs supported by display device 40a, and/or any other suitable information about display device 40a. In such embodiments, content server 30 may transmit to display device 40a only the copies of media files 60 that satisfy or match the transmitted device parameters 46.

At an appropriate point after display device 40a begins receiving media files 60 from the relevant bin 70, display device 40a initiates playback of the received media files 60. In particular embodiments, display device 40a may initiate playback of media files 60 as soon as display device 40a receives all or an appropriate portion of the first media file 60 from the identified bin 70. In alternative embodiments, display device 40a may initiate playback of media files 60 only after receiving all the media files 60 stored in the relevant bin 70 (or the subset of those media files 60 designated for transmission to display device 40a). In particular embodiments, display device 40a plays all media files 60 from the identified bin 70 seamlessly one after another.

Additionally, in particular embodiments, display device 40a may initiate playback of the received media files 60 in a portion of the associated webpage 22 display device 40a initially received from web server 20. In particular embodiments, webpage 22 may represent a news article and multiple media files 60 representing video footage associated with the news article may be displayed in a captioned portion of the article. For example, the news article may recap a recent sporting event, and media files 60 capturing highlights from that sporting event may be displayed in the appropriate portion of the article after such media files 60 are retrieved from a bin 70 associated with the article.

As a result, in particular embodiments, system 10 allows multiple subscribers 80 to incorporate content provided by content provider 82 into webpages 22 provided by those subscribers 80. Because web servers 20 transmit bin identifiers 28 to display device 40 instead of the location of individual media files 60, subscriber 80 can make a large number of media files 60 available to display devices 40 by incorporating only a single bin identifier 28 into webpages 22. This may allow a subscriber 80 with limited technical skills to easily incorporate multiple different media files 60 into webpages 22 generated by that subscriber 80.

Furthermore, because media files 60 can be dynamically associated with bins 70, bin identifiers 28 can be communicated to web server 20 by content server 30 and/or content provider 82 before media files 60 have even been generated. For example, the operator of content server 30 can generate a bin identifier 28 for a bin 70 that will hold media files 60 showing highlights from a sporting event before the sporting event begins and communicate the bin identifier 28 to news providers reporting on the event. The news providers can then generate a webpage 22 that recaps the event and incorporates the relevant bin identifier 28 before the media files 60 are even available for download from content server 30. As a result, system 10 provides significant flexibility to subscribers 80 in generating webpages 22 without regard for the actual media files 60 that will be played along with those webpages 22.

Moreover, because web server 20 transmits player 24 to display devices 40 (e.g., as part of webpages 22), in particular embodiments, subscriber 80 can increase the likelihood that users 84 can play media files 60 from subscriber's bin 70 regardless of the applications currently installed on their display devices 40. As a result, in particular embodiments, subscriber 80 and/or content provider 82 does not need to maintain a separate copy of each media file 60 for each of various different media players. This may further simplify the storage and/or use of media files 60.

In addition, in particular embodiments, a subscriber 80 may be able to customize the manner in which media content is distributed to users 84 accessing that subscriber's web server 20. In particular embodiments, a subscriber 80 may be able to configure one or more bins 70 associated with that subscriber 80. For example, each subscriber 80 may maintain an account with content provider 82 that is associated with one or more bins 70. Each subscriber 80 may be capable of configuring the bins 70 associated with that subscriber's account to specify the media files 60 to be stored in the associated bins 70, the media files 60 to be transmitted from the associated bins 70, the users 84 which can access the associated bins 70, and/or any other appropriate aspect of how content server 30 manages or utilizes the associated bins 70. Although subscribers 80 may perform this configuration in any appropriate manner based on the capabilities and characteristics of system 10, FIG. 1 illustrates an example of how configuration may be performed in a particular embodiment of system 10.

More specifically, in the illustrated embodiment, subscriber 80 is able to transmit configuration information 92 to content server 30 as part of a configuration request 90. Configuration information 92 may be any information specifying media files 60 to be stored in or transmitted from bins 70 or the manner in which media files 60 should be stored in or transmitted from bins 70. Moreover, configuration request 90 can represent any form of command, message, request, or other type of communication that includes configuration information 92 or otherwise specifies a configuration for one or more bins 70. For example, in particular embodiments, subscriber 80 may access content server 30 over network 50 using a conventional web browser and a personal computer (not shown). By navigating and completing one or more webpage forms, subscriber 80 may enter configuration information 92 that may be transmitted to content server 30 as part of a configuration request 90, such as an HTTP request.

In particular embodiments, a subscriber 80 can indicate to content server 30 specific media files 60 to include in the bin 70 associated with that subscriber's account. Subscriber 80 may do this by transmitting a configuration request 90 to content server 30 that indicates one or more media files 60 to be stored in the associated bin 70. For example, in particular embodiments, a subscriber 80 may be able to browse a selection of media files 60 offered by content provider 82 and choose one or more to make available in that subscriber's bin 70. This subscriber 80 may then transmit to content server 30 a configuration request 90 that identifies the selected media files 60. Subscribers 80 may also be able to upload media files 60 of their own to content server 30 for storage in their associated bin 70. Thus, as another example, a musician can upload digital music recordings to content server 30 for playback to users 84 accessing a webpage 22 or webpages 22 created by the musician (such as the musician's homepage).

Furthermore, in particular embodiments, a subscriber 80 may be able to indicate general categories of media files 60 to include in the associated bin 70. For example, in particular embodiments, subscriber 80 may transmit a configuration request 90 that includes configuration information 92 identifying a type of media file 60 to be included in the associated bin 70. Content server 30 and/or content provider 82 may then store media files 60 of that type in the associated bin 70. The type may relate to the subject matter of the relevant media files 60, the file format of these media files 60, the creation date of the media files 60, and/or any other aspect or characteristic of the relevant media files 60 or the content contained in them. Thus, based on the type or types specified for by a particular subscriber 80, content server 30 may store particular media files 60 in the bin 70 associated with that subscriber 80. Moreover, in particular embodiments, as content provider 82 creates or makes more media files 60 available on content server 30, content server 30 may update the content stored in bins 70 based on the types specified by the associated subscribers 80.

Additionally, in particular embodiments, a subscriber 80 may be able to transmit a configuration request 90 that includes configuration information 92 specifying a particular subset of media files 60, a certain type of media file 60 to be transmitted (or no to be transmitted) to display devices 40 or policies for determining the media files 60 to transmit. When content server 30 subsequently receives a media request 44 from a display device 40 requesting content from a particular bin 70, content server 30 may identify a subset of the media files 60 in that bin 70 based on this configuration information 92 and transmit to the requesting display device 40 only the identified media files 60.

As one example, in particular embodiments, subscriber 80 may not be permitted to distribute all media files 60 in the associated bin 70 because actors, musicians, creators, or other persons having rights in the relevant media files 60 have not authorized subscriber 80 to distribute such media files 60 or have only authorized subscriber 80 to distribute such media files 60 in certain circumstances or under certain conditions. As a result, subscriber 80 may transmit configuration information 92 that configures content server 30 to select media files 60 for transmission based on a clearance status of the relevant media files 60. Thus, media files 60 can be stored in bins 70 while subscriber 80 seeks appropriate clearance to transmit those media files 60. Moreover, in particular embodiments, subscriber 80 may be able to transmit configuration information 92 representing clearance policies that specify the conditions under which particular media files 60 may be distributed. As a result, when content server 30 receives a media request 44 requesting content from the associated bin 70, content server 30 may identify a subset of the media files 60 stored in that bin 70 to transmit to the requesting display device 40 based on the clearance status of the identified media files 60.

As another example, subscriber 80 may transmit configuration information 92 that configures content server 30 to randomly select a subset of media files 60 stored in the associated bin 70. When content server 30 subsequently receives a media request 44 requesting content from the associated bin 70, content server 30 may randomly select a subset of the media files 60 included in that bin 70 and transmit the selected media files 60 to the requesting display device 40. As a result, users 84 will be presented a random selection of media files 60 when accessing webpages 22 from that subscriber 80. Thus, as one example, a subscribing animator could provide a changing collection of the animator's cartoons to visitors to the animator's website using system 10.

As a result, subscribers 80, in particular embodiments, are capable of customizing the manner in which content is delivered to users 84 viewing webpages 22 provided by those subscribers 80. Moreover, this customization can be done with minimal technical expertise on the part of subscribers 80. Consequently, subscribers 80 can easily integrate content stored in bins 70 into webpages 22 created by subscribers 80.

Furthermore, particular embodiments of system 10 may also be capable of supporting additional content-management services involving the media files 60 stored in bins 70. In particular, content provider 82 may be responsible for selling or licensing media files 60 in the various bins 70 maintained on content server 30. As a result, a user 84 may be able to purchase, license, or otherwise acquire rights in one or more of the media files 60 retrieved from the identified bin 70. In particular embodiments, webpage 22 may include information and interface elements (such as HTML forms and buttons) sufficient to allow user 84 to initiate a transaction by which that user 84 acquires rights in one or more of the media files 60 retrieved from the identified bin 70 or other media files 60 associated with the retrieved media files 60 (e.g., full-length versions of samples retrieved from bin 70).

For example, in particular embodiments, webpages 22 may include a “Purchase” button or similar interface elements that a user 84 can click to transfer a media file 60 currently being played as part of webpage 22 to a virtual “shopping cart” created for that user 84. After selecting the desired media files 60, user 84 can then electronically initiate a purchase of the media files 60 in the shopping cart. As a result of the purchase, the purchased media files 60 may be saved to display device 40, copies of the purchased media file 60 may be delivered to user 84, digital rights information encoded in the purchased media files 60 may be modified, or user 84 may otherwise be granted rights in or access to the relevant media files 60.

Alternatively, after indicating a desire to initiate a transaction relating to one of the retrieved media files 60, a user 84 may be forwarded to transaction webpages stored on content server 30 (or other components of system 10 operated by content provider 82). Content server 30 may communicate one or more transaction webpages to display device 40a to guide user 84 through the process of purchasing, licensing, or acquiring rights in the desired media files 60. As a result, subscriber 80 can offload the technological and commercial responsibilities of handling such transactions, in part or in whole, to content provider 82.

Consequently, in particular embodiments, subscriber 80 may be able to outsource the selling and licensing of media files 60 through use of system 10. More specifically, content provider 82 may manage sales and/or licensing of media files 60 owned by a number of different subscribers 80 and, thus, allow subscribers 80 who lack the technological and commercial expertise to operate their own electronic commerce (“e-commerce”) systems. As a result, subscribers 80 such as amateur musicians and cinematographers can distribute media files 60 despite lacking extensive technical expertise.

Thus, overall, system 10 may provide a flexible and effective way for subscriber 80 to distribute multimedia content to users 84 for viewing, purchase, and/or other purposes. As discussed above, particular embodiments provide a number of operational benefits. Nonetheless, specific embodiments may provide some, none, or all of these benefits.

FIG. 2 is a block diagram illustrating the contents of a particular embodiment of content server 30 that may be utilized in system 10. As shown in FIG. 2, content server 30 includes a processor 102, memory 104, and a network interface 106. Additionally, memory 104 is divided into a plurality of bins 70 that each store media files 60. Although FIG. 2 illustrates the contents of a particular embodiment of content server 30, content server 30 may, as noted above, represent or include any appropriate combination of hardware and/or software suitable to provide the described functionality.

Processor 102 may represent a dedicated microprocessor, general-purpose computer, or other processing device capable of processing and communicating electronic information. In particular embodiments, processor 102 operates, at least in part, by executing instructions stored in memory 104 and/or elsewhere within system 10. Examples of processor 102 include application-specific integrated circuits (ASICs), field-programmable gate arrays (FPGAs), digital signal processors (DSPs) and any other suitable specific or general purpose processors. Although FIG. 2 illustrates a particular embodiment of content server 30 that includes a single processor 102, content server 30 may, in general, include any suitable number of processors 102.

Memory 104 stores processor instructions, subscriber information, configuration information, and/or other data or information utilized by content server 30 during operation. Memory 104 may comprise any collection and arrangement of volatile or non-volatile, local or remote devices suitable for storing data such as, for example, random access memory (RAM) devices, read only memory (ROM) devices, magnetic storage devices, optical storage devices, or any other suitable data storage devices. Additionally, as shown in FIG. 2, a portion of memory 104 may be divided into one or more bins 70 for storage of media files 60.

As noted above with respect to FIG. 1, bins 70 may represent file system folders, directories, or any other form of logical partition in which a group of media files 60 may be stored. In particular embodiments, each bin 70 holds a collection of associated media files 60. For example, each bin 70 may hold a collection of media files 60 associated with a particular subscriber 80, media files 60 related to a particular subject or subjects, and/or media files 60 associated in any appropriate manner.

Network interface 106 facilitates communication between content server 30 and other components of system 10 over network 50. Network interface 106 may include any appropriate combination of hardware and/or software suitable to facilitate interaction between content server 30 and other components of system 10. In particular embodiments, network interface 106 may represent or include a Network Interface Card (NIC) and any appropriate controlling logic.

FIGS. 3A-3? show examples of code that may be used to implement various aspects of the operation described above with respect to FIG. 2. More specifically, [TBD]

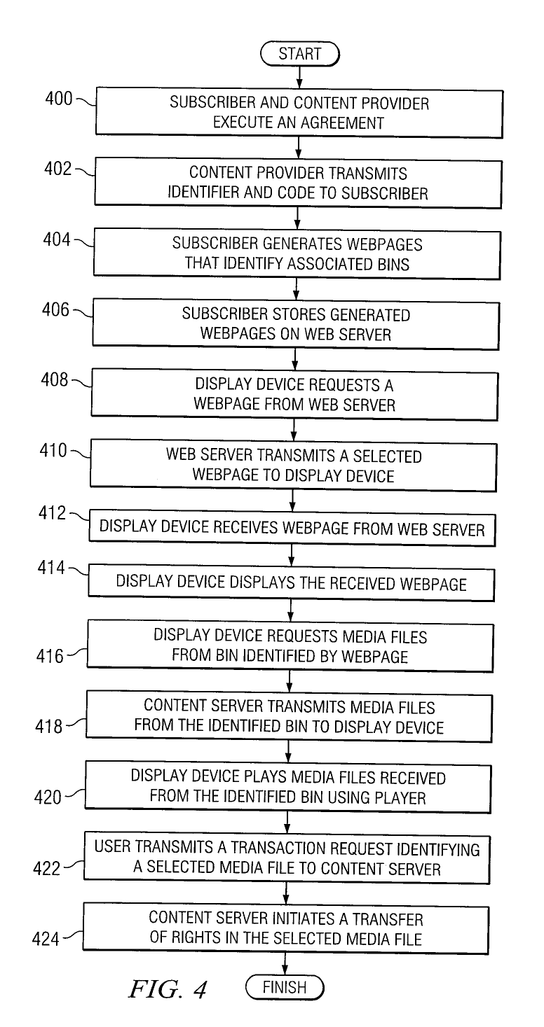

FIG. 4 is a flowchart illustrating example operation of one embodiment of system 10 in delivering content to a particular display device 40. In general, the steps illustrated in FIG. 4 may be combined, modified, or deleted where appropriate. Additional steps may also be added to the example operation. Furthermore, the described steps may be performed in any suitable order without departing from the scope of the invention.

Operation begins at step 400 with content server 82 and one or more subscribers 80 executing an agreement 32 relating to media files 60. In particular embodiments, agreement 32 may identify the media files 60 and the services to be provided with respect to these media files 60. After executing agreement 32, content provider 82 transmits to subscriber 80 a bin identifier 28, code, and/or other information that will be used by subscribers 80 or users 84 to access media files on content server 30, at step 402.

At step 404, a particular subscriber 80 and/or web server 20 generates one or more webpages 22 that identify bins 70 that store or will store media files 60 associated with those webpages 22. In particular embodiments, webpages 22 identify the associated bins 70 by incorporating a bin identifier 28 specifying the identity or location of the associated bin 70. At step 406, subscriber 80 and/or web server 20 stores the generated webpages 22 on web server 20.

At step 408, a display device 40 requests a webpage 22 from web server 20. As noted above, display device 40 may request webpage 22 by transmitting a webpage request 42, such as an HTTP request, to web server 20. In response to webpage request 42, web server 20 transmits a selected webpage 22 to display device 40 at step 410. Display device 40 receives webpage 22 from web server 20 at step 412. At step 414, display device 40 displays the received webpage 22 to user 84.

While display device 40 displays the received webpage 22, display device 40 may request media files 60 from the bin 70 or bins 70 identified by the bin identifiers 28 included in the received webpage 22 at step 416. In particular embodiments, display device 40 may request media files 60 by transmitting a media request 42, such as an HTTP request, that identifies the relevant bin 70 or bins 70 (e.g., by including any received bin identifier 28 in media request 42).

In response to receiving media request 42 from display device 40, content server 30 transmits media files 60 from a bin 70 identified by media request 42 to display device 40 at step 418. As noted above, content server 30 may, in particular embodiments, transmit to display device 40 all media files 60 in the identified bin 70. Alternatively, in particular embodiments, content server 30 may transmit only a portion of the media files 60 in the identified bin 70 based on how the relevant subscriber 80 has configured the identified bin 70, based on device parameters 46 describing the capabilities of the requesting display device, and/or based on any other appropriate considerations.

At an appropriate point, display device 40 plays media files 60 received from the identified bin 70 using player 82, shown in FIG. 4, at step 420. In particular embodiments, display device 40 plays the received media files 60 in a predetermined portion of the associated webpage 22. For example, if webpage 22 represents an article, display device 40 may play the received media files 60 in a framed portion of the webpage 22 that includes a caption describing the contents of the media files 60 being played.

In particular embodiments, display device 40 may initiate playback of the received media files 60 as soon as display device 40 receives the first media file 60 from the identified bin 70. In alternative embodiments, display device 40 may wait until receiving all media files 60 from the identified bin 70 before initiating playback. In yet other embodiments, display device 40 may wait until receiving input from user 84 requesting playback of the relevant media files 60. For example, display device 40 may display a cursor on a display screen that user 84 can move within the display screen using an input device such as a mouse. In such embodiments, display device 40 may be configured to initiate playback of media files 60 when user 84 moves the cursor into a portion of the display screen associated with media files 60 (e.g., a framed portion of the webpage 22 reserved for playback of media files 60). Display device 40 may, in general, be configured to initiate playback of media files 60 at any appropriate time after receiving any portion of one or more media files 60 from the identified bin 70.

In addition to playing media files 60 retrieved from content server 30, user 84 may be able to purchase, license, or otherwise acquire rights in such media files 60. As noted above, the transfer of rights initiated by content server 30 may involve a purchase of the selected media file 60, a license to limited or unlimited use of the media file, or any other suitable transfer of rights in the selected media file 60. Moreover, the transfer may be completed in any appropriate manner based on the configuration and capabilities of system 10. A description of one example of this process is shown in steps 422-424 of FIG. 4.

More specifically, at step 422, user 84 indicates a desire to purchase a particular one of the received media files 60 or a media file 60 related to one of these received media files 60. In the illustrated example, user 84 indicates this desire by transmitting a transaction request to content server 30. For example, in particular embodiments, webpage 22 may include a “Purchase” button or other interface elements that user 84 can click to indicate a desire to purchase the media file 60 currently being played. In response, display device 40 may transmit an HTTP request identifying the selected media file 60 to content server 30 or other elements of system 10 responsible for processing purchase requests. In particular embodiments, content server 30 may additionally transmit one or more webpages to display device 40 to request information to be used to complete the transfer such as the name of user 84, payment information, or the type of transfer desired. In such embodiments, information entered by the user in response to these webpages may also be provided as part of the transaction request.

Content server 30 responds to the purchase request by initiating a transfer of some or all rights in the selected media file 60 at step 424. Additionally, content server 30 may initiate this transfer by taking any appropriate steps, depending on the configuration and capabilities of content server 30, to facilitate such a transfer. For example, content server 30 may initiate the transfer by transmitting a copy of the relevant media file 60 to user 84 (e.g., to display device 40, an email address provided by user 84, or an account associated with user 84), modifying digital rights information in the received copy of media file 60, electronically executing a license with user 84 involving the selected media file 60, or taking any other appropriate steps to facilitate the transfer.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims. For example, any of the above described functionality may be implemented in hardware, in software (such as computer-executable instructions encoded in electronic media and/or transmission signals), and/or any suitable combination of the two.

What is claimed is:

1. A method for distributing time-based media files, comprising:
executing an agreement with a subscriber, the agreement relating to a plurality of time-based media files;
communicating an identifier to the subscriber that identifies a location of at least a portion of the time-based media files associated with the agreement;
receiving a media request from one of a plurality of display devices that receive the identifier from the subscriber, wherein the media request includes the identifier; and
in response to receiving the media request, transmitting a plurality of media files associated with the agreement to the display device that transmitted the media request.

2. The method of claim 1, further comprising:
generating a webpage that includes the identifier, wherein the identifier identifies a bin storing a plurality of time-based media files; and
transmitting the webpage to a display device.

3. The method of claim 2, wherein the webpage further comprises a player, and further comprising:
loading the player at the display device; and
playing, with the player, the transmitted media files.

4. The method of claim 2, wherein generating the webpage comprises:
generating the webpage; and
storing the web page on a first device, and wherein the media request comprises receiving the media request at a second device.

5. The method of claim 1, wherein the time-based media files comprise motion imagery.

6. The method of claim 1, wherein the time-based media files comprise audio information.

7. The method of claim 1, further comprising:
receiving a content selection request from the subscriber identifying one or more time-based media files; and
storing the identified media files in a bin associated with the subscriber.

8. The method of claim 1, further comprising:
receiving a content selection request from the subscriber identifying a type of time-based media file; and
storing time-based media files associated with the identified type in a bin associated with the subscriber.

9. The method of claim 1, wherein transmitting a plurality of the media files stored in the bin to the display device comprises transmitting a randomly-selected subset of the media files stored in the bin to the display device.

10. The method of claim 1, wherein transmitting a plurality of the media files stored in the bin comprises:
identifying a plurality of the media files stored in the bin based on a clearance status associated with each of the identified media files; and
transmitting the identified media files to the display device.

11. The method of claim 1, wherein transmitting a plurality of the media files stored in the bin to the display device comprises:
receiving device parameters from the display device;
identifying a plurality of the media files stored in the bin based on the device parameters; and
transmitting the identified media files to the display device.

12. The method of claim 11, wherein the device parameters comprise a display size, and wherein identifying the plurality of media files comprises identifying one or more time-based media files stored in the bin that are associated with the display size.

13. The method of claim 1, further comprising:
receiving a transaction request from the display device; and
in response to receiving the transaction request, electronically initiating a transfer of rights in the time based media.

14. The method of claim 13, wherein electronically initiating a transfer of rights comprises electronically initiating a sale of the time-based media file.

15. The method of claim 13, wherein electronically initiating a transfer of rights comprises electronically executing a license agreement associated with the time-based media file.

16. A system for distributing time-based media files, comprising:
a display device operable to play media files;
a web server operable to:
store a webpage, wherein the webpage comprises a bin identifier identifying a bin storing a plurality of time-based media files;
receive a request for the webpage from the display device;
in response to the request, transmit the webpage to the display device; and
a content server operable to:
store media files in each of a plurality of bins;
receive a request for media files, wherein the request identifies one of the plurality of bins; and
in response to the request for media files, transmit a plurality of the media files stored in the identified bin to the display device.

17. The system of claim 16, wherein the webpage further comprises a player, and wherein the display device is operable to play media files by:
loading the player; and
playing, with the player, media files transmitted by the content server.

18. The system of claim 16, wherein the time-based media files comprise motion imagery.

19. The system of claim 16, wherein the time-based media files comprise audio information.

20. The system of claim 16, wherein each bin is associated with a subscriber, and wherein the content server is further operable to:
receive a configuration request from a subscriber identifying one or more time-based media files; and
store the identified media files in the bin associated with that subscriber.

21. The system of claim 16, wherein each bin is associated with a subscriber, and wherein the content server is further operable to:
receive a configuration request from a subscriber identifying a type of time-based media file; and
store time-based media files associated with the identified type in the bin associated with that subscriber.

22. The system of claim 16, wherein the content server is operable to transmit a plurality of the media files stored in the identified bin to the display device by transmitting a randomly-selected subset of the media files stored in the identified bin to the display device.

23. The system of claim 16, wherein the content server is operable to transmit a plurality of the media files stored in the identified bin to the display device by:
identifying a plurality of the media files stored in the identified bin based on a clearance status associated with each of the identified media files; and
transmitting the identified media files to the display device.

24. The system of claim 16, wherein the content server is operable to transmit a plurality of the media files stored in the identified bin to the display device by:
receiving device parameters from the display device;
identifying a plurality of the media files stored in the identified bin based on the device parameters; and
transmitting the identified media files to the display device.

25. The system of claim 24, wherein the device parameters comprise a display size, and wherein identifying the plurality of media files comprises identifying a plurality of time-based media files stored in the bin that are associated with the display size.

26. The system of claim 16, wherein the content server is further operable to:
receive a transaction request from the display device; and
in response to receiving the transaction request, electronically initiate a transfer of rights in the time based media.

27. The system of claim 26, wherein the content server is operable to electronically initiate a transfer of rights by electronically initiating a sale of the time-based media files.

28. The system of claim 26, wherein the content server is operable to electronically initiate a transfer of rights by electronically executing a license agreement associated with the time-based media file.

29. A computer product comprising computer-executable instructions encoded in electronic media, the instructions operable, when executed, to:
generate a webpage that comprises a bin identifier, wherein the bin identifier identifies a bin storing a plurality of time-based media files;
transmit the webpage to a display device;
receive, from the display device, a media request that includes the bin identifier; and
in response to receiving the media request, transmit a plurality of the media files stored in the bin to the display device.

30. A system for distributing time-based media files, comprising:
means for generating a webpage that comprises a bin identifier, wherein the bin identifier identifies a bin storing a plurality of time-based media files;
means for transmitting the webpage to a display device;
means for receiving, from the display device, a media request that includes the bin identifier; and
means for transmitting a plurality of the media files stored in the bin to the display device in response to receiving the media request.
